(19) United States
(12) Patent Application Publication
(10) Pub. No.: US 2009/0035578 A1
(43) Pub. Date: Feb. 5, 2009

(54) IRREGULAR-SHAPED PARTICLE, IRREGULAR-SHAPED PARTICLE COMPOSITION, METHOD FOR PRODUCING SAME, AND LIGHT DIFFUSION MOLDED ARTICLE

(75) Inventors: Yasuhisa Watanabe, Tokyo (JP); Kazuaki Itou, Tokyo (JP); Akira Nishikawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, TOKYO (JP)

(21) Appl. No.: 12/162,403

(22) PCT Filed: Jan. 25, 2007
(86) PCT No.: PCT/JP2007/051206

§ 371 Date: Oct. 3, 2008

(30) Foreign Application Priority Data
Jan. 27, 2006 (JP) 2006-018629

(51) Int. Cl. B32B 5/16; C08L 37/00; G02B 5/02

(52) U.S. Cl. 428/402; 525/208; 428/327; 359/599

(57) ABSTRACT

Irregular-shaped particles each comprising
particle (a) composed of a first polymer, and
particle (b) composed of a second polymer, disposed on at least part of the surface of the particle (a),
   and having a number-average particle diameter of 0.8 to 10 μm.

### TECHNICAL FIELD

The present invention relates to irregular-shaped particles capable of providing a light diffusion molded article superior in light diffusion property, etc., an irregular-shaped particle composition and a process for producing the composition, and a light diffusion molded article superior in light diffusion property, etc.

### BACKGROUND ART

Liquid crystal display device is currently in use as a display device of TV, personal computer or the like. This liquid crystal display device comprises a light source, a light guide panel arranged in the vicinity of the light source and illuminated by the light source, a light diffusion panel, a prism sheet and a liquid crystal display panel (the light diffusion panel, prism sheet and liquid crystal display panel are provided in front of the light guide panel in this order). The light diffusion panel arranged in front of the light guide panel is used in order to diffuse the light (which has passed through the light guide panel) more uniformly. Attempts have been made to improve the property of the light diffusion panel for enhancing the luminance of the liquid crystal display device.

As a relevant prior art, there is a disclosure of a light diffusion panel using light-diffusing resin particles whose average particle diameter and coefficient of variation (CV) of particle diameter distribution are set in given ranges (see, for example, Patent Document 1).

However, even with the light diffusion panel using light-diffusing resin particles, described in the Patent Document 1, the luminance of the liquid crystal display device obtained is not sufficiently enhanced, and further improvement has been desired. Specifically explaining, it has been desired to develop a light diffusion panel which is good in light transmission property and light diffusion property and higher in luminance. In order to satisfy such a desire, there is a disclosure of a light diffusion panel using synthetic resin particles whose average particle diameter and average particle diameter distribution are set in given ranges (see, for example, Patent Document 2).

However, even in the light diffusion panel using synthetic resin particles, described in the Patent Document 2, there is still room for improvement on the light transmission property and light diffusion property; and it has been desired to develop a light diffusion molded article of higher property and a material allowing for product ion of such a light diffusion molded article.

Patent Document 1: JP 1995-234304 A

Patent Document 2: JP 2004-226604 A

### DISCLOSURE OF THE INVENTION

The present invention has been made in view of the above-mentioned problems of prior art. The present invention aims at providing irregular-shaped particles capable of providing a light diffusion molded article superior in light transmission property and light diffusion property, an irregular-shaped particle composition and a process for producing the composition, and a light diffusion molded article superior in light transmission property and light diffusion property.

The present inventors made a study in order to achieve the above aim. As a result, it was found that the above aim could be achieved by using irregular-shaped particles each constituted by two or more particles, whose number-average particle diameter is set in a given numerical range. The finding has led to the completion of the present invention.

According to the present invention, there are provided irregular-shaped particles, an irregular-shaped particle composition and a process for producing the composition, and a light diffusion molded article, all described below.

[1] Irregular-shaped particles each comprising

particle (a) composed of a first polymer, and

particle (b) composed of a second polymer, disposed on at least part of the surface of the particle (a),

and having a number-average particle diameter of 0.8 to 10 μm.
[2] Irregular-shaped particles according to [1], wherein at least one kind of the monomer units contained in the first polymer is different from the monomer units contained in the second polymer.
[3] Irregular-shaped particles according to [1] or [2], wherein the ratio of the number-average particle diameter (Lₐ) of the particle (a) and the number-average particle diameter (L_{b}) of the particle (b) is (Lₐ)/(L_{b})=0.05 to 20.0.
[4] Irregular-shaped particles according to any one of [1] to [3], wherein the first polymer contains

60 to 98% by mass of (a1) an aromatic vinyl type monomer unit,

2 to 40% by mass of (a2) a polar functional group-containing monomer unit, and

0 to 38% by mass of (a3) other monomer unit and (a1)+(a2)+(a3)=100% by mass.

[5] Irregular-shaped particles according to any one of [1] to [4], wherein the second polymer contains

0 to 25% by mass of (b1) an aromatic vinyl type monomer unit,

75 to 100% by mass of (b2) a polar functional group-containing monomer unit, and

0 to 25% by mass of (b3) other monomer unit and (b1)+(b2)+(b3)=100% by mass.

[6] Irregular-shaped particles according to any one of [1] to [5], wherein the particle (b) is a polymer formed by seed polymerization in which the particle (a) is used as a seed polymer particle.
[7] An irregular-shaped particle composition containing

(A) irregular-shaped particles set forth in any one of [1] to [6], and

(B) a binder component.

[8] A process for producing an irregular-shaped particle composition, which comprises

a step of removing a solvent from an emulsion containing irregular-shaped particles set forth in any one of [1] to [6], to obtain the irregular-shaped particles of dry state, and

a step of mixing the irregular-shaped particles obtained, with a binder component.

[9] A light diffusion molded article (hereinafter referred to as “a first light diffusion molded article”) composed of a resin material containing

a resin component, and

irregular-shaped particles set forth in any one of [1] to [6].

[10] A light diffusion molded article according to [9], which is a light guide panel, a light diffusion panel or a light diffusion film.
[11] A light diffusion molded article (hereinafter referred to as “a second light diffusion molded article”) having

a substrate layer, and

a light diffusion layer composed of an irregular-shaped particle composition set forth in [7], formed on at least one side of the substrate layer.

[12] A light diffusion molded article according to [11], which is a light diffusion panel or a light diffusion film.

The irregular-shaped particles of the present invention can provide a light diffusion molded article superior in light transmission property and light diffusion property.

The irregular-shaped particle composition of the present invention can provide a light diffusion molded article superior in light transmission property and light diffusion property.

According to the process for producing irregular-shaped particles, of the present invention, there can be produced an irregular-shaped particle composition capable of providing a light diffusion molded article superior in light transmission property and light diffusion property.

The first and second light diffusion molded articles of the present invention are superior in light transmission property and light diffusion property.

### BRIEF DESCRIPTION OF THE DRAWINGS

FIG. 1(a) is a schematic drawing showing an embodiment of the irregular-shaped particles of the present invention.

FIG. 1(b) is a schematic drawing showing other embodiment of the irregular-shaped particles of the present invention.

FIG. 1(c) is a schematic drawing showing still other embodiment of the irregular-shaped particles of the present invention.

FIG. 1(d) is a schematic drawing showing still other embodiment of the irregular-shaped particles of the present invention.

FIG. 1(e) is a schematic drawing showing still other embodiment of the irregular-shaped particles of the present invention.

FIG. 1(f) is a schematic drawing showing still other embodiment of the irregular-shaped particles of the present invention.

FIG. 2 is a schematic drawing explaining the major diameter and minor diameter of irregular-shaped particle.

FIG. 3(a) is a schematic drawing showing an initial stage of the growth of particle (b).

FIG. 3(b) is a schematic drawing showing an intermediate stage of the growth of particle (b).

FIG. 3(c) is a schematic drawing showing a final stage of the growth of particle (b).

### EXPLANATION OF SYMBOLS

1 is a particle (a); 2 is a particle (b); 5 is an irregular-shaped particle; D is a minor diameter; and L is a major diameter.

### BEST MODE FOR CARRYING OUT THE INVENTION

The best mode for carrying out the present invention is described below. However, the present invention is not restricted to the following embodiment and it should be construed that appropriate changes, modifications, etc. can be added to the following embodiment based on the ordinary knowledge possessed by those skilled in the art as long as there is no deviation from the gist of the present invention and that the embodiments after such changes, modifications, etc. fall as well in the range of the present invention. Incidentally, in the present invention, when there is used a mere expression of “the light diffusion molded article of the present invention (the present embodiment)”, it means both of the first light diffusion molded article and the second light diffusion molded article.

### 1. Irregular-Shaped Particles

An embodiment of the irregular-shaped particles of the present invention is irregular-shaped particles each comprising

particle (a) composed of a first polymer, and

particle (b) composed of a second polymer, disposed on at least part of the surface of the particle (a),

and having a number-average particle diameter of 0.8 to 10 μm. In-depth description thereof is made below.

### (Particle (a))

The particle (a) constituting the irregular-shaped particles of the present embodiment is composed of a first polymer. The first polymer is preferably a seed polymer particle capable of absorbing an oil-soluble polymerization initiator containing an organic compound whose water-solubility is 10⁻²% by mass or less. Specifically, there can be mentioned styrene-based polymers such as styrene-based polymer, styrene-butadiene copolymer and the like and acrylic ester-based polymers, etc.

The first polymer constituting the particle (a) is preferred to contain, as the constituent units, for example,

(a1) an aromatic vinyl type monomer unit (hereinafter, referred to also as “constituent unit (a1)”),

(a2) a polar functional group-containing monomer unit (hereinafter, referred to also as “constituent unit (a2)”), and

(a3) other monomer unit (hereinafter, referred to also as “constituent unit (a3)”).

(Aromatic Vinyl Type Monomer Unit (a1))

As the aromatic vinyl type monomer used for formation of the constituent unit (a1), there can be mentioned styrene, α-methylstyrene, vinyltoluene, p-methylstyrene, 2-methylstyrene, 3-methylstyrene, 4-methylstyrene, 4-ethylstyrene, 4-tert-butylstyrene, 3,4-dimethylstyrene, 4-methoxystyrene, 4-ethoxystyrene, 2-chlorostyrene, 3-chlorostyrene, 4-chlorostyrene, 2,4-dichlorostyrene, 2,6-dichlorostyrene, 4-chloro-3-methylstyrene, divinylbenzene, 1-vinylnaphthalene, 2-vinylpyridine, 4-vinylpyridine, etc. Of these, preferred are styrene, divinylbenzene and α-methylstyrene. These aromatic vinyl type monomers can be used singly or in admixture of two or more kinds.

The proportion of the constituent unit (a1) contained in the first polymer is preferably 60 to 98% by mass, more preferably 65 to 95% by mass, particularly preferably 70 to 90% by mass when the total of the constituent unit (a1), the constituent unit (a2) and the constituent unit (a3) is taken as 100% by mass. When the proportion of the constituent unit (a1) contained in the first polymer is less than 60% by mass, there is a tendency of inferior light diffusion property. Meanwhile, when the proportion is more than 98% by mass, it tends to be difficult to obtain irregular-shaped particles.

(Polar Functional Group-Containing Monomer Unit (a2))

The polar functional group-containing monomer used for formation of the constituent unit (a2) is a monomer having a polar functional group in the molecule. As preferred examples of the polar functional group, there can be mentioned carboxyl group, cyano group, hydroxyl group, glycidyl group and ester group. As specific examples of the polar functional group-containing monomer, there can be mentioned monomers shown in the following (1) to (5). Incidentally, the monomers shown below can be used singly or in combination of two or more kinds.

(1) carboxyl group-containing monomers: carboxyl group-containing unsaturated monomers and anhydrides thereof, such as (meth)acrylic acid, crotonic acid, cinnamic acid, maleic acid, maleic anhydride, fumaric acid, itaconic acid, itaconic anhydride, monomethyl maleate, monoethyl maleate, monomethyl itaconate, monoethyl itaconate, mono-2-(meth)acryloyloxyethyl hexahydrophthalate and the like. Of these, (meth)acrylic acid is preferred.
(2) Cyano group-containing monomers: vinyl cyanide type monomers such as (meth)acrylonitrile, crotononitrile, cinnamonitrile and the like; 2-cyanoethyl(meth)acrylate, 2-cyanopropyl(meth)acrylate, and 3-cyanopropyl(meth)acrylate. Of these, (meth)acrylonitrile is preferred.
(3) Hydroxyl group-containing monomers: hydroxy(cyclo)alkyl mono(meth)acrylates such as hydroxymethyl(meth)acrylate, 2-hydroxyethyl(meth)acrylate, 6-hydroxyhexyl(meth)acrylate, 4-hydroxycyclohexyl(meth)acrylate, neopentyl glycol mono(meth)acrylate and the like; and substituted hydroxy(cyclo)alkyl mono(meth)acrylates such as 3-chloro-2-hydroxypropyl(meth)acrylate, 3-amino-2-hydroxypropyl (meth)acrylate and the like. Of these, hydroxymethyl (meth)acrylate is preferred.
(4) Glycidyl group-containing monomers: allyl glycidyl ether, glycidyl(meth)acrylate, methylglycidyl methylacrylate, and epoxidized cyclohexyl(meth)acrylate. Of these, glycidyl (meth)acrylate is preferred.
(5) Ester group-containing monomers: (cyclo)alkyl (meth)acrylates such as methyl(meth)acrylate, ethyl (meth)acrylate, propyl(meth)acrylate, n-hexyl(meth)acrylate, 2-ethylhexyl(meth)acrylate, cyclohexyl(meth)acrylate and the like; alkoxy(cyclo)alkyl(meth)acrylates such as 2-methoxyethyl(meth)acrylate, p-methoxycyclohexyl (meth)acrylate and the like; multivalent(meth)acrylates such as trimethylolpropane tri(meth)acrylate and the like; and vinyl esters such as vinyl acetate, vinyl propionate, vinyl versatate and the like. Of these, methyl(meth)acrylate is preferred.

The proportion of the constituent unit (a2) contained in the first polymer is preferably 2 to 40% by mass, more preferably 4 to 35% by mass, particularly preferably 8 to 30% by mass when the total of the constituent unit (a1), the constituent unit (a2) and the constituent unit (a3) is taken as 100% by mass. When the proportion of the constituent unit (a3) contained in the first polymer is less than 2% by mass, it tends to be difficult to obtain irregular-shaped particles. Meanwhile, when the proportion is more than 40% by mass, there is a tendency of inferior light transmission property.

### (Other Monomer Unit)

The first polymer may contain, as necessary, a monomer unit (referred to also as constituent unit (a3)) composed of other monomer copolymerizable with the above-mentioned monomers. As the other monomer composing the constituent unit (a3), the following monomers can be mentioned.

N-methylol unsaturated carboxylic acid amides such as N-methylol(meth)acrylamide, N,N-dimethylol (meth)acrylamide and the like; aminoalkyl group-containing acrylamides such as 2-dimethylaminoethylacrylamide and the like; amides or imides of unsaturated carboxylic acids, such as (meth)acrylamide, N-methoxymethyl(meth)acrylamide, N,N-ethylenebis(meth)acrylamide, maleic acid amide, maleimide and the like; N-monoalkyl(meth)acrylamides and N,N-dialkylacrylamides such as N-methylacrylamide, N,N-dimethylacrylamide and the like; aminoalkyl group-containing (meth)acrylates such as 2-dimethylaminoethyl(meth)acrylate and the like; aminoalkoxyalkyl group-containing (meth)acrylates such as 2-(dimethylaminoethoxy)ethyl (meth)acrylate and the like; vinyl halide compounds such as vinyl chloride, vinylidene chloride, fatty acid vinyl esters and the like; and conjugated diene compounds such as 1,3-butadiene, 2-methyl-1,3-butadiene, 2-chloro-1,3-butadiene, 2,3-dimethyl-1,3-butadiene and the like.

### (Particles (b))

The particle (b) constituting the irregular-shaped particles of the present embodiment is composed of a second polymer. The second polymer is preferred to contain, as the constituent units, for example,

(b1) an aromatic vinyl type monomer unit (hereinafter, referred to also as “constituent unit (b1)”),

(b2) a polar functional group-containing monomer unit (hereinafter, referred to also as “constituent unit (b2)”), and

(b3) other monomer unit (hereinafter, referred to also as “constituent unit (b3)”).

(Aromatic Vinyl Type Monomer Unit (b1))

As the aromatic vinyl type monomer used for formation of the constituent unit (b1), there can be mentioned the same aromatic vinyl type monomers as used for formation of the above-mentioned constituent unit (a1). Of them, styrene, divinylbenzene and α-methylstyrene are preferred. These aromatic vinyl type monomers can be used singly or in combination of two or more kinds.

The proportion of the constituent unit (b1) contained in the second polymer is preferably 0 to 250% by mass, more preferably 10 to 200% by mass, particularly preferably 20 to 150% by mass when the total of the constituent unit (a1), the constituent unit (a2) and the constituent unit (a3) is taken as 100% by mass. When the proportion of the constituent unit (a1) contained in the first polymer is more than 250% by mass, there is a tendency of inferior light transmission property.

(Polar Functional Group-Containing Monomer Unit (b2))

The polar functional group-containing monomer used for formation of the constituent unit (b2) is a monomer having a polar functional group in the molecule. As preferred examples of the polar functional group, there can be mentioned carboxyl group, cyano group, hydroxyl group, glycidyl group and ester group. As specific examples of the polar functional group-containing monomer, there can be mentioned the same polar functional group-containing monomers used for formation of the above-mentioned constituent unit (a2). Of them, ester group-containing monomers are preferred, and more preferred are (cyclo)alkyl(meth)acrylates such as methyl(meth)acrylate and the like and multivalent (meth)acrylates such as diethylene glycol di(meth)acrylate, trimethylolpropane tri(meth)acrylate and the like. These polar functional group-containing monomers can be used singly or in combination of two or more kinds.

The proportion of the constituent unit (b2) contained in the second polymer is preferably 75 to 100% by mass, more preferably 75 to 95% by mass, particularly preferably 80 to 90% by mass when the total of the constituent unit (b1), the constituent unit (b2) and the following constituent unit (b3) is taken as 100% by mass. When the proportion of the constituent unit (b3) contained in the second polymer is less than 75% by mass, there is a tendency of inferior light transmission property.

### (Other Monomer Unit)

The second polymer may contain, as necessary, a monomer unit (referred to also as constituent unit (b3)) composed of other monomer copolymerizable with the above-mentioned monomers. As the other monomer composing the constituent unit (b3), there can be mentioned the same other monomers as may be used for formation of the above-mentioned constituent unit (a3).

### (Irregular-Shaped Particles)

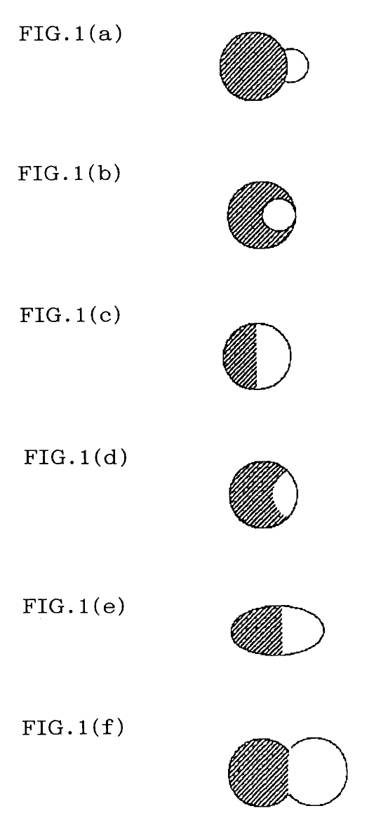

The irregular-shaped particles of the present embodiment each comprise the particle (a) and the particle (b). The particle (b) is disposed on at least part of the surface of the particle (a). In the present Description, “irregular-shaped” means that the above two particles are disposed asymmetrically relative to the center of the two particles. The concept of “irregular-shaped particles” referred to in the present Description includes all particles having the above-mentioned asymmetry, such as cases in which the shape of whole particle is a spherical shape as shown in FIGS. 1(b) to 1(d), a rugby ball shape as shown in FIG. 1(e), a twin-ball shape as shown in FIG. 1(f) or a sphere having a spherical projection as shown in FIG. 1(a).

In the irregular-shaped particles of the present embodiment, the composition of the first polymer and the composition of the second polymer may be the same or different from each other. However, it is preferred that at least one kind of the monomer units contained in the first polymer is different from the monomer units contained in the second polymer. In this case, it follows that at least one kind of the monomer units constituting each irregular-shaped particle is contained only in either of the first polymer and the second polymer. Thereby, for example, the primary particle (a) and the primary particle (b) can be separated asymmetrically.

In the irregular-shaped particles of the present embodiment, the ratio of the number-average (L) of major diameter and the number-average (D) of minor diameter, i.e. (L)/(D) is preferably 1.0 to 2.0, more preferably 1.1 to 1.9, particularly preferably 1.2 to 1.8. When the (L)/(D) is more than 2.0, the dispersion of the irregular-shaped particles in the binder component is low and it tends to be difficult to obtain uniform light diffusion property.

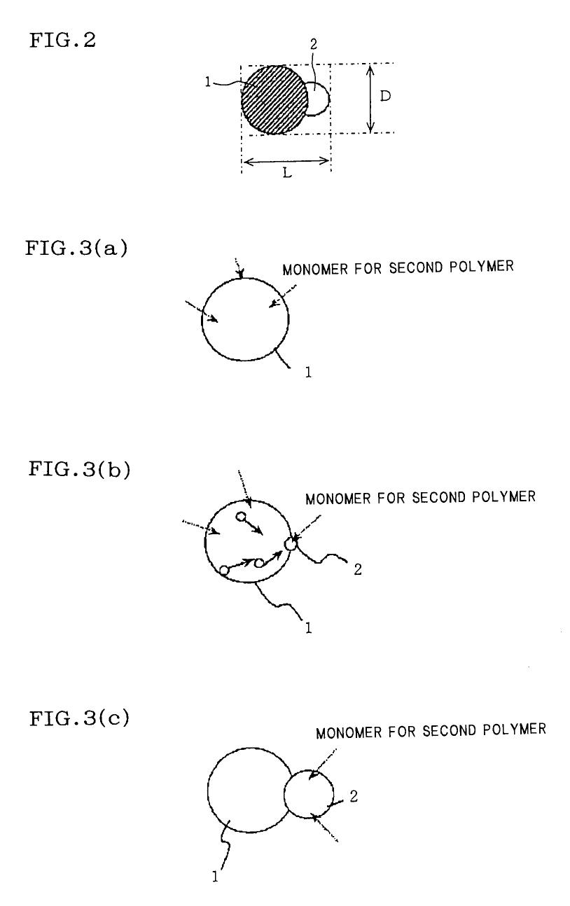

Here, explanation is made on the “major diameter” and “minor diameter” when the irregular-shaped particles have a spherical shape having a spherical projection, such as shown in FIG. 1(a). As shown in FIG. 2, the major diameter (L) is shown as a distance from the end of particle (a), i.e. 1 to the end of particle (b), i.e. 2. The minor diameter (D) is a diameter of larger particle (particle (a), i.e. 1 in FIG. 2).

In the irregular-shaped particles of the present embodiment, the ratio of the number-average particle diameter (Lₐ) of particle (a) and the number-average particle diameter (L_{b}) of particle (b), i.e. (Lₐ)/(L_{b}) is preferably 0.05 to 20.0, more preferably 0.2 to 18, particularly preferably 0.4 to 15. When the (Lₐ)/(L_{b}) is less than 0.05, there is a tendency of strikingly inferior balance of light transmission property and light diffusion property. Meanwhile, when the (Lₐ)/(L_{b}) is more than 20.0, there is as well a tendency of strikingly inferior balance of light transmission property and light diffusion property. Incidentally, when the irregular-shaped particles are not truly spherical but, for example, compressed, the average of major diameter and minor diameter is taken as “average particle diameter”.

In the irregular-shaped particles of the present embodiment, the ratio of the refractive index (Rₐ) of the particle (a) and the refractive index (R_{b}) of the particle (b), i.e. (Rₐ)/(R_{b}) is preferably 0.7 to 1.4, more preferably 0.8 to 1.3, particularly preferably 0.85 to 1.25. When the (Rₐ)/(R_{b}) is less than 0.7, it tends to be difficult to obtain irregular-shaped particles. Meanwhile, when the (Rₐ)/(R_{b}) is more than 1.4, it tends to be difficult as well to obtain irregular-shaped particles. Incidentally, the refractive index is a value obtained by measurement by the following method.

### Measurement of Refractive Index:

(1) Particles to be measured are dried at 80° C. for 24 hours, then ground and filtered through a 60-mesh wire net to prepare a test sample (dried primary articles).
(2) The dried primary particles are mixed with a refractive index standard solution (produced by Cargille) having an appropriate refractive index to prepare a primary particles dispersion.
(3) The primary particles dispersion is observed with a microscope to examine whether or not the outline portion of primary particles can be seen visually. When the outline portion could not be seen, the refractive index of the refractive index standard solution was taken as a “refractive index” of the particles.

In the irregular-shaped particles of the present embodiment, it is preferred that the first polymer and/or the second polymer has at least one kind of reactive functional group, because the polymerization stability tends to be kept well easily. As the “reactive functional group”, there can be mentioned ester group, amide group, amino group, carboxyl group, sulfonic acid group, sulfuric acid group, glycidyl group and hydroxyl group. The polymer having a reactive functional group(s) (ester group, amide group, amino group, carboxyl group, glycidyl group or/and hydroxyl group) can be obtained, for example, by copolymerizing a monomer having such a reactive functional group(s) or by grafting a compound having such a reactive functional group(s). The polymer having sulfonic acid group can be obtained, for example, by polymerizing a monomer in the presence of a reactive surfactant having sulfonic acid group. The polymer having sulfuric acid group can be obtained, for example, by polymerizing a monomer using an initiator such as potassium persulfate or the like. The amount of the reactive functional group contained in the first polymer and/or the second polymer is preferably 0.5 to 50% by mass, more preferably 2 to 30% by mass in each polymer, in terms of the compound used for introduction of reactive functional group.

### (Process for Production of Irregular-Shaped Particles)

The irregular-shaped articles of the present embodiment can be produced, for example, by a process shown below. First, the particle (a) composed of the first polymer can be obtained by ordinary emulsion polymerization using an aqueous medium. The “aqueous medium” refers to a medium composed mainly of water. The specific content of water in the aqueous medium is preferably 40% by mass or more, more preferably 50% by mass or more. As other medium usable in combination with water, there can be mentioned compounds such as esters, ketones, phenols, alcohols and the like.

The conditions of the emulsion polymerization may be those used in known emulsion polymerization. For example, the emulsion polymerization can be conducted using ordinarily 100 to 500 parts of water when the total amount of monomers used is 100 parts, under conditions of a polymerization temperature of −10 to 100° C. (preferably −5 to 100° C., more preferably 0 to 90° C.) and a polymerization time of 0.1 to 30 hours (preferably 2 to 25 hours). As the mode of emulsion polymerization, there can be employed, for example, a batch mode in which monomers are fed in one portion, a mode in which monomers are fed in portions or continuously, a mode in which a pre-emulsion of monomers is added in portions or continuously, or a mode in which the above modes are combined in stages. It is possible to use, as necessary, one or two members selected from a molecular weight modifier, a chelating agent, an inorganic electrolyte, etc., all used in ordinary emulsion polymerization.

When an initiator is used in the emulsion polymerization, there can be used, as the initiator, persulfates such as potassium persulfate, ammonium persulfate and the like; organic peroxides such as benzoyl peroxide, lauroyl peroxide, tert-butylperoxy-2-ethyl hexanoate and the like; azo compounds such as azobisisobutyronitrile, dimethyl-2,2′-azobisisobutyrate, 2-carbamoylazaisobutyronitrile and the like; redox type initiators which are each a combination of a radical emulsifier containing a peroxide group-containing, radical emulsifiable compound and a reducing agent such as sodium hydrogensulfite, ferrous sulfate or the like; and so forth. When an emulsifier is used, there can be used, as the emulsifier, at least one member selected from the group consisting of a known anionic emulsifier, a nonionic emulsifier and an amphoteric emulsifier. It is also possible to use, for example, a reactive emulsifier having unsaturated double bond in the molecule.

As to the molecular weight modifier used in the emulsion polymerization, there is no particular restriction. As specific examples of the molecular weight modifier, there can be mentioned mercaptans such as n-hexylmercaptan, n-octylmercaptan, n-dodecylmercaptan, tert-dodecylmercaptan, n-hexadecylmercaptan, n-tetradecylmercaptan, tert-tetradecylmercaptan, thioglycolic acid and the like; xanthogen disulfides such as dimethylxanthogen disulfide, diethylxanthogen disulfide, diisopropylxanthogen disulfide and the like; thiuram disulfides such as tetramethylthiuram disulfide, tetraethylthiuram disulfide, tetrabutylthiuram disulfide and the like; halogenated hydrocarbons such as chloroform, carbon tetrachloride, carbon tetrabromide, ethylene bromide and the like; hydrocarbons such as pentaphenylethane, α-methylstyrene dimer and the like; acrolein, methacrolein, allyl alcohol, 2-ethylhexyl thioglycolate, terpinolene, α-terpinene, γ-terpinene, dipentene, and 1,1-diphenylethylene. These molecular weight modifiers can be used singly or in combination of one or two kinds. Of these, preferably used are mercaptans, xanthogen disufides, thiuram disulfides, 1,1-diphenylethylene, α-methylstyrene dimer, etc.

The conversion of monomers at the completion of the emulsion polymerization is preferably 80% by mass or more, more preferably 90% by mass or more, particularly preferably 95% by mass or more. When monomers for second polymer are fed in a state that the conversion of monomers for first polymer is less than 80% by mass, clear separation between the particle (a) formed and the particle (b) formed is difficult. The formed particle (a) composed of a first polymer is ordinarily a spherical particle. The number-average particle diameter of the particle (a) is preferably 0.8 to 10 μm, more preferably 1.0 to 10 μm. When the number-average particle diameter of the particle (a) is outside the range, it may be difficult to produce the particle (a) by emulsion polymerization.

Monomers for second polymer are polymerized in the presence of the particle (a) obtained. More specifically, monomers for second polymer are seed-polymerized in a state that the particle (a) obtained is used as a seed polymer particle, whereby a particle (b) can be formed. For example, monomers for second polymer or a pre-emulsion thereof can be dropped in one portion, in portions or continuously into an aqueous dispersion in which the particle (a) is dispersed. The amount of the particle (a) used in this case is preferably 1 to 100% by mass, more preferably 2 to 80% by mass relative to 100 parts by mass of the monomers for second polymer. When, in the polymerization, an initiator and an emulsifier are used, there can be used the same initiator and emulsifier as used in production of the particle (a). Also, the conditions such as polymerization time and the like may be the same as used in production of the particle (a).

When the monomers for second polymer are fed into an aqueous medium in which the particle (a) is dispersed, the most part of the fed monomers for second polymer is ordinarily occluded once into the particle (a), as shown in FIG. 3(a), and polymerization starts in the particle (a) or on the surface thereof. With progress of the polymerization, the monomers for second polymer come to have a lower compatibility with the first polymer and cause phase separation from the first polymer. Therefore, at the initial period, the polymerization proceeds at plural sites of the particle (a); however, in a case that the monomer units of the two polymers satisfy the above-mentioned respective relations, the second polymer formed at various sites of the particle (a) get together and tend to form a single particle (b) (see FIG. 3(b)). When the particle (b) has grown into a certain size, subsequent polymerization proceeds at this particle (b) (see FIG. 3(c)). In this way, there are formed irregular-shaped particles of the present embodiment in which the particle (a) and the particle (b) are separated asymmetrically.

In the thus-formed, irregular-shaped particles of the present embodiment, the number-average particle diameter is 0.8 to 10 μm, preferably 1.0 to 10 μm, more preferably 1.2 to 10 μm. When the number-average particle diameter is larger than 10 μm, production by emulsion polymerization may be difficult. When the number-average particle diameter is smaller than 0.8 μm, the balance between light transmission property and light diffusion property is inferior. Incidentally, in the irregular-shaped particles of the present embodiment, the “number-average particle diameter” is a length in the longest direction of irregular-shaped particle and can be measured, for example, by light scattering method.

In the irregular-shaped particles of the present embodiment, the mass ratio ((a)/(b)) of the particle (a) and the particle (b) is preferably 2/98˜98/2, more preferably 5/95˜95/5. In the total surface area of the irregular-shaped particles, the proportions (areal ratio=(a)/(b)) of the exposed surface of the particle (a) and the exposed surface of the particle (b) is preferably 5/90˜95/5, more preferably 10/95˜90/10. When one of the above proportions of either of the particle (a) and the particle (b) is smaller than the above range, it may be impossible to sufficiently obtain the effect brought about by the “irregular shape” of the irregular-shaped particles. Incidentally, the proportion of the exposed surface of each primary particle in the total surface area of the irregular-shaped particles can be measured, for example, from photomicrograph.

The shape of each irregular-shaped particle varies depending upon the mass ratio of particle (a) and particle (b), the separation state of particle (a) and particle (b), the polymerization conditions employed in formation of particle (b), etc. For example, when the mass ratio of particle (a) and particle (b) and the polymerization conditions are fixed, the shape of the irregular-shaped particle tends to vary in the order of FIG. 1(b), FIG. 1(d) and FIG. 1(a) as the separation state of particle (a) and particle (b) gets higher.

### 2. Irregular-Shaped Particle Composition and Process for Production Thereof

An embodiment of the irregular-shaped particle composition of the present invention contains

(A) the above-mentioned irregular-shaped particles, and

(B) a binder component.

In-depth explanation thereof is made below.

### Binder Component (B)

As to the kind of the binder component contained in the irregular-shaped particle composition of the present embodiment, there is no particular restriction as long as the binder component is transparent and can allow the irregular-shaped particles (A) to be dispersed and bound on the surface of, for example, a resin-made sheet. As specific examples of the binder component, there can be mentioned thermoplastic resins such as polyvinyl acetate, polyvinyl alcohol, polyvinyl chloride, polyvinyl butyral, poly(meth)acrylic acid ester, nitrocellulose and the like; and thermosetting resins such as phenolic resin, melamine resin, polyester resin, polyurethane resin, epoxy resin and the like. These binder components can be used singly or in combination of two or more kinds.

The total light transmission of the binder component is preferably 80% or more, more preferably 90% or more. When the total light transmission of the binder component is more than 80%, a light diffusion molded article higher in light transmission property can be produced. Incidentally, the “total light transmission” referred to in this Description is a value obtained by measurement based on JIS K 7105.

The proportion of the binder component (B) contained in the irregular-shaped particle composition of the present embodiment is preferably 1 to 10,000 parts by mass, more preferably 2 to 5,000 parts by mass, particularly preferably 3 to 1,000 parts by mass relative to 100 parts by mass of the irregular-shaped particles (A). When the proportion of the binder component (B) is less than 1 part by mass, it tends to be difficult to disperse and to bind irregular-shaped particles (A) on the surface of, for example, a resin-made sheet. Meanwhile, when the proportion of the binder component (B) is more than 10,000 parts by mass, the light diffusion molded article produced with such an irregular-shaped particle composition tends to show no further increase in light transmission property and light diffusion property.

### (Other Components)

The irregular-shaped particle composition of the present embodiment can contain as necessary, besides the irregular-shaped particles (A) and the binder component (B), other components such as curing agent, dispersing agent, dye and the like.

The proportion of other components is preferably 0 to 10 parts by mass, more preferably 0 to 5 parts by mass, particularly preferably 0 to 3 parts by mass relative to 100 parts by mass of the total of the irregular-shaped particles (A) and the binder component (B).

### (Process for Production of Irregular-Shaped Particle Composition)

In producing the irregular-shaped particle composition of the present embodiment, first, the solvent in the irregular-shaped particles-containing emulsion obtained by the above-mentioned process for production of irregular-shaped particles is removed from the emulsion to obtain irregular-shaped particles of dry state (step (1)). In the step (1), as to the method for removal of the solvent from the emulsion, there is no particular restriction. However, freeze-drying or spray-drying is preferred because the dry state can be attained easily.

The drying is conducted until the proportion of the remaining solvent becomes preferably 5.0% by mass or less, more preferably 3.0% by mass or less. When the proportion of the remaining solvent is more than 5.0% by mass, the dispersion of irregular-shaped particles into the binder component is low and it tends to be difficult to produce a molded article of uniform light diffusion property.

Then, the obtained irregular-shaped particles of dry state are mixed with the binder component (step (2)). In the step (2), the irregular-shaped particles, the binder component, and the above-mentioned other components added as necessary are mixed uniformly, whereby the irregular-shaped particle composition of the present embodiment can be obtained. Incidentally, the other components may be mixed later. As to the mixing method, there is no particular restriction. However, mixing can be conducted by using, for example, a kneader, a beads mill or a high-pressure homogenizer.

### 3. Light Diffusion Molded Article

The first light diffusion molded article of the present invention is composed of a resin material containing a resin component and the above-mentioned irregular-shaped particles. An embodiment of the second light diffusion molded article of the present invention has a substrate layer and a light diffusion layer composed of the above-mentioned irregular-shaped particle composition, formed on at least one side of the substrate layer. In-depth explanation is made below on each of the first and second light diffusion molded articles.

### (First Light Diffusion Molded Article)

The resin material composing the first light diffusion molded article contains a resin component and the above-mentioned irregular-shaped particles. As to the resin component, there is no particular restriction. However, the resin component is preferred to be transparent and have high transmission property to visible light. Incidentally, the “transparent” includes conceptually colorless and transparent, colored and transparent, and translucent.

The resin component, when made into a sheet of 200 μm in thickness, has a transmission to a light of 550 nm wavelength, of preferably 80% or more, more preferably 85% or more, particularly preferably 90% or more because such a resin component can provide a light diffusion molded article of very high light transmission property. In view of the use environment, storage environment, etc. of the light diffusion molded article obtained, the resin component further has a glass transition temperature of preferably 100° C. or more, more preferably 120° C. or more, particularly preferably 150° C. or more.

As specific examples of the resin component, there can be mentioned thermoplastic resins such as polyethylene terephthalate, polymethyl(meth)acrylate, polycarbonate, cycloolefin polymer, polyallylate, polyethersulfone, polystyrene, methyl(meth)acrylate-styrene copolymer, styrene-acrylonitrile copolymer and the like; and thermosetting resins curable by heat or actinic ray, such as epoxy resin, vinyl ether resin, (meth)acrylate having two or more (meth)acrylic groups, oxetane resin, vinyl ester resin and the like. Of these, thermosetting resins curable by heat or actinic ray are preferred because they can be easily made composite with a glass fiber or a glass fiber fabric and are stable thermally; and an epoxy resin and a (meth)acrylate having two or more (meth)acrylic groups are more preferred.

The proportion of the irregular-shaped particles in the resin material is preferably 1 to 1,000 parts by mass, more preferably 1 to 500 parts by mass, particularly preferably 1 to 100 parts by mass relative to 100 parts by mass of the resin component. When the proportion of the irregular-shaped particles is less than 1 part by mass, it tends to be difficult to obtain sufficiently high light diffusion property. Meanwhile, when the proportion is more than 1,000 parts by mass, there is a tendency of strikingly low light transmission property.

The first light diffusion molded article of the present embodiment can be produced, for example, by feeding the resin component and the irregular-shaped particles into an extruder and extruding them from the extruder to obtain a master batch, then feeding the master batch into an extruder and injecting it into a cavity to obtain a molded article.

The first light diffusion molded article of the present embodiment has superior light transmission property and light diffusion property. Therefore, utilizing these properties, the first light diffusion molded article of the present embodiment is suitably used as a light guide panel, a light diffusion panel, a light diffusion film, etc.

### (Second Light Diffusion Molded Article)

The substrate layer constituting the second light diffusion molded article is preferably a layer composed of a transparent resin (transparent is colorless and transparent, colored and transparent or translucent). As specific examples of the resin constituting the substrate layer, there can be mentioned the same resin component as contained in the resin material constituting the above-mentioned first light diffusion molded material.

The light diffusion layer formed on at least one side of the substrate layer is a layer composed of the above-mentioned, irregular-shaped particle composition. The irregular-shaped particles contained in the irregular-shaped particle composition are uniformized on the substrate layer by the binder component also contained in the irregular-shaped particle composition. Incidentally, part of the irregular-shaped particles may be partially projected from the surface of the binder component. Also, the projected portion of irregular-shaped particle may be totally or partially covered with the binder component. Or, the irregular-shaped particles may be wholly buried in the binder component.

The second light diffusion molded article of the present embodiment can be produced, for example, by dispersing or dissolving the irregular-shaped particles (A) and the binder component (B) in (C) an organic solvent capable of dispersing or dissolving the (A) and (B), to obtain a slurry, coating the slurry using a coater of any kind, and drying the slurry. As specific examples of the organic solvent (C), there can be mentioned water, toluene, cyclohexane, methyl isobutyl ketone (MIBK), methyl ethyl ketone (MEK), and N-methyl-2-pyrrolidone (NMP).

The proportion of the organic solvent (C) is preferably 10 to 2,000 parts by mass, more preferably 20 to 1,000 parts by mass relative to 100 parts by mass of the total of the irregular-shaped particles (A) and the binder component (B).

As to the thickness of the substrate layer, there is no particular restriction. However, the thickness is ordinarily about 0.03 to 0.3 mm, preferably about 0.05 to 0.2 mm. As to the thickness of the light diffusion layer, there is no particular restriction, either. However, the thickness is ordinarily about 0.01 to 0.1 mm, preferably about 0.02 to 0.08 mm.

The second light diffusion molded article of the present embodiment has superior light transmission property and light diffusion property. Therefore, utilizing these properties, the second light diffusion molded article of the present embodiment is suitably used as a light diffusion panel, a light diffusion film, etc.

### EXAMPLES

The present invention is described specifically below by way of Examples. However, the present invention is not restricted to these Examples. In the following Examples and Comparative Examples, “parts” and “%” are based on mass unless otherwise specified. The methods used for measurement and evaluation of properties are shown below.

### [Number-Average Particle Diameter]

Measured using a laser particle diameter analysis system (trade name: “LS 13320”) produced by Beckman Coulter.

### [Number-Average Major Diameter (L) and Number-Average Minor Diameter (D)]

Measured by observation using a SEM.

### [Total Light Transmittance]

Measured based on JIS K 7105 using a haze meter produced by Suga Test Instruments. (a sample-free state, i.e. air was taken as 100%).

### [Haze]

Measured based on JIS K 7105 using a haze meter produced by Suga Test Instruments.

### 1. Synthesis of Polymer Particle

### Example 1

2 parts of 3,5,5-trimethylhexanoyl peroxide [“Peroyl 355” (trade name), produced by Nippon Oils and Fats, water solubility: 0.01%], 0.1 part of sodium lauryl sulfate and 20 parts of water were emulsified by stirring. The emulsion was made into smaller particles using a ultrasonic homogenizer to obtain an aqueous dispersion. To the aqueous dispersion obtained were added 15 parts of monodisperse polystyrene particles having a number-average particle diameter of 1.0 μm, followed by stirring for 16 hours. Then, 70 parts of styrene (ST), 20 parts of divinylbenzene (DVB) and 10 parts of glycidyl methacrylate (GMA) were added. The mixture was slowly stirred at 40° C. for 3 hours to allow the monodisperse polystyrene particles to absorb the monomer components (ST, DVB and GMA). Thereafter, the mixture was heated to 75° C. and a polymerization reaction was conducted for 3 hours, to obtain an emulsion containing particles (a) composed of a first polymer. Incidentally, the particles (a) had a number-average particle diameter of 1.8 μm and there was substantially no formation of coagulation product.

22.1 parts of the same aqueous dispersion as the above-mentioned aqueous dispersion and 20 parts (in terms of solid content) of the above-mentioned emulsion containing particles (a) were mixed and stirred for 16 hours. Then, thereto were added 90 parts of MMA and 10 parts of trimethylolpropane trimethacrylate (TMPMA), followed by slow stirring at 40° C. for 3 hours to allow the particles (a) to absorb the monomer components (MMA and TMPMA). Thereafter, the mixture was heated to 75° C. and a polymerization reaction was conducted for 3 hours to form particles (b) composed of second polymer to obtain an emulsion containing polymer particles [a polymer (A)] each composed of a particle (a) and a particle (b). The shape of each polymer particle was irregular [daruma (a sphere having a spherical projection)-shaped]; the number-average particle diameter of the particles (b) was 1 μm; the number-average particle diameter of the polymer particles was 3.5 μm; the (L)/(D) ratio was 1.6; the Lₐ (μm)/L_{b} (μm) was 1.9/2.6; and there was substantially no formation of coagulation product.

### Examples 2 and 3, Comparative Examples 1 to 4

Emulsions each containing one of polymer particles [polymers (C) to (G)] were obtained in the same manner as in Example 1 except that the compounding formulation of first polymer and second polymer was as shown in Table 1 (in Comparative Examples 1 and 2, no second polymer was formed). The properties of each polymer are shown in Table 1.

TABLE 1

| | | | Example 1 | Example 2 | Example 3 | Comparative | Comparative | Comparative | Comparative |
|---|---|---|---|---|---|---|---|---|---|
| | | | Polymer | Polymer | Polymer | Example 1 | Example 2 | Example 3 | Example 4 |
| | | | (A) | (B) | (C) | Polymer (D) | Polymer (E) | Polymer (F) | Polymer (G) |
| Compounding | Particle (a) | Monodisperse | 15 | 12 | 15 | 12 | 5 | 12 | 12 |
| formulation | (first polymer) | polystyrene | | | | | | | |
| (parts) | | particle | | | | | | | |
| | | ST | 70 | 70 | 70 | 70 | — | 70 | 70 |
| | | DVB | 20 | 20 | 20 | 20 | — | 20 | 20 |
| | | GMA | 10 | 10 | 10 | 10 | — | 10 | 10 |
| | | MMA | — | — | — | — | 90 | — | — |
| | | TMPMA | — | — | — | — | 10 | — | — |
| | Particle (a) (first | First polymer | 20 | 20 | 50 | — | — | 20 | 20 |
| | polymer) + particle | MMA | 90 | 90 | 90 | — | — | 90 | 90 |
| | (b) (second polymer) | TMPMA | 10 | 10 | 10 | — | — | 10 | 10 |
| Properties | Number-average | Particle (a) | 1.9 | 1.11 | 1.62 | — | — | 0.39 | 0.58 |
| | particle diameter | Particle (b) | 2.6 | 1.56 | 1.91 | — | — | 0.43 | 0.82 |
| | (μm) | Whole particle | 3.5 | 1.6 | 2.5 | 2 | 3 | 0.5 | 0.7 |
| | (L)/(D) ratio | | 1.6 | 1.6 | 1.7 | 1 | 1 | 1.7 | 1.6 |
| | Lₐ (μm)/L_{b} (μm) | | 1.9/2.6 | 1.11/1.56 | 1.62/1.91 | — | — | 0.39/0.43 | 0.58/0.82 |
| | Particle shape | | Irregular | Irregular | Irregular | Spherical | Spherical | Irregular | Irregular |

### 2. Preparation of Polymer Compositions and Production of Light Diffusion Molded Articles

### Example 4

The emulsion containing polymer (A) was dried using a spray drier (Model “L-8”, produced by Ohkawara Kakouki) to obtain a powdery polymer (A). 50 parts of polymethyl methacrylate (a poly MMA) (“PARAPET HR-L” (trade name) produced by Kuraray, melt index: 2 g/10 min) and 200 parts of methyl isobutyl ketone (MIBK) were mixed. 50 parts of the powdery polymer (A) were added to the resulting mixture and dispersed therein, to obtain a polymer composition.

Then, the polymer composition was coated in a uniform layer on a polyethylene terephthalate (PET)-made substrate (total light transmission: 87.3%, haze: 2.8%, thickness: 200 μm). Thereafter, drying was conducted at 60° C. for 3 hours to obtain a light diffusion film (Example 4) having a light diffusion layer of 25 μm in thickness. The light diffusion film had a total light transmission of 100% and a haze of 92.4% and was balanced very well.

### Examples 5 to 7 and Comparative Examples 5 to 9

Polymer compositions were obtained in the same manner as in Example 4 except that each compounding formulation shown in Table 2 was used. Using the polymer compositions, light diffusion films (Examples 5 to 7 and Comparative Examples 5 to 9) were obtained in the same manner as in Example 4. The thickness of light diffusion layer, total light transmission and haze of each light diffusion film obtained are shown in Table 2.

TABLE 2

| | Compounding formulation (parts) | | | | Thickness of light | Total light | |
|---|---|---|---|---|---|---|---|
| | Poly MMA | Solvent | Particle | | diffusion layer | transmission | Haze |
| | (binder component) | (MIBK) | (Polymer) | (Parts) | (μm) | (%) | (%) |
| Example 4 | 50 | 200 | (A) | 50 | 25 | 100 | 92.4 |
| Example 5 | 50 | 200 | (A) | 50 | 38 | 100 | 92.6 |
| Example 6 | 50 | 200 | (B) | 50 | 37 | 99.5 | 91.1 |
| Example 7 | 50 | 200 | (C) | 50 | 34 | 100 | 93.2 |
| Comparative | 50 | 200 | (D) | 50 | 30 | 89.2 | 92.2 |
| Example 5 | | | | | | | |
| Comparative | 50 | 200 | (E) | 50 | 33 | 99.7 | 82.2 |
| Example 6 | | | | | | | |
| Comparative | 50 | 200 | (D) + (E) | 50 | 30 | 99.8 | 88.5 |
| Example 7 | | | | | | | |
| Comparative | 50 | 200 | (F) | 50 | 39 | 91.4 | 69.3 |
| Example 8 | | | | | | | |
| Comparative | 50 | 200 | (G) | 50 | 34 | 94.3 | 71.0 |
| Example 9 | | | | | | | |
| Substrate*¹ | — | — | — | — | — | 87.3 | 2.8 |
| Blank*² | — | — | — | — | 22 | 88.2 | 2.8 |

*¹PET (thickness: 200 μm)
*²PET (thickness: 200 μm) + poly MMA layer (thickness: 2.2 μm)

### (Discussion)

As is clear from Table 2, the light diffusion films of Examples 4 to 7, produced using the polymer particles of Examples 1 to 3, as compared with the light diffusion films of Comparative Examples 5 to 9, produced using the polymer particles of Comparative Examples 1 to 4, are highly superior in balance between total light transmission and haze.

Incidentally, the light diffusion film of Comparative Example 7 was produced using a mere blend of the polymer (A) of spherical shape and the polymer (B) of spherical shape. It is clear that a mere blend of different particles using no irregular-shaped particle is unable to achieve an enhanced haze. Further, the light diffusion films of Comparative Examples 8 and 9 using the polymer (F) and the polymer (G) which were irregular-shaped but had each a number-average particle diameter of less than 0.8 μm, were low in any of total light transmittance and haze.

### INDUSTRIAL APPLICABILITY

The light diffusion molded article of the present invention is suitably used as a light guide panel, a light diffusion panel and a light diffusion film.

1. Irregular-shaped particles each comprising
particle (a) comprising a first polymer, and
particle (b) comprising a second polymer, disposed on at least part of the surface of the particle (a), and
having a number-average particle diameter of 0.8 to 10 μm.

2. The irregular-shaped particles according to claim 1, wherein at least one kind of monomer units comprised in the first polymer is different from monomer units comprised in the second polymer.

3. The irregular-shaped particles according to claim 1, wherein a ratio of a number-average particle diameter (La) of the particle (a) and a number-average particle diameter (Lb) of the particle (b) is (La)/(Lb)=0.05 to 20.0.

4. The irregular-shaped particles according to claim 1, wherein the first polymer comprises:
60 to 98% by mass of (a1) an aromatic vinyl type monomer unit,
2 to 40% by mass of (a2) a monomer unit having a polar functional group, and
0 to 38% by mass of (a3) another monomer unit and (a1)+(a2)+(a3)=100% by mass.

5. The irregular-shaped particles according to claim 1, wherein the second polymer comprises:
0 to 25% by mass of (b1) an aromatic vinyl type monomer unit, 75 to 100% by mass of (b2) a monomer unit having a polar functional group, and
0 to 25% by mass of (b3) another monomer unit and (b1)+(b2)+(b3)=100% by mass.

6. The irregular-shaped particles according to claim 1, wherein the particle (b) is a polymer formed by seed polymerization in which the particle (a) is used as a seed polymer particle.

7. An irregular-shaped particle composition comprising:
(A) irregular-shaped particles set forth in claim 1, and
(B) a binder component.

8. A process for producing an irregular-shaped particle composition, which comprises
removing a solvent from an emulsion comprising irregular-shaped particles set forth in claim 1, to obtain the irregular-shaped particles in a dry state, and
mixing the irregular-shaped particles obtained with a binder component.

9. A light diffusion molded article comprising a resin material, said material comprising:
a resin component, and
irregular-shaped particles set forth in claim 7.

10. A light diffusion molded article according to claim 9, which is a light guide panel, a light diffusion panel or a light diffusion film.

11. A light diffusion molded article having
a substrate layer, and
a light diffusion layer comprising an irregular-shaped particle composition set forth in claim 7, formed on at least one side of the substrate layer.

12. A light diffusion molded article according to claim 11, which is a light diffusion panel or a light diffusion film.
